(19) United States
(12) Patent Application Publication
(10) Pub. No.: US 2003/0142038 A1
(43) Pub. Date: Jul. 31, 2003

(54) Remote markup of a display device using a wireless internet appliance as an electronic canvas

(75) Inventor: Robert H. Folk II, Narberth, PA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/062,785

(22) Filed: Jan. 31, 2002

(51) Int. Cl. G09G 5/00

(52) U.S. Cl. 345/2.1

(57) ABSTRACT

The present invention provides a method and device that allows a viewer to generate and overlay graphical data onto video images displayed on local and remote devices via a network such as the Internet. The method comprises inputting at least one instruction corresponding to a graphic into an input device; storing the at least one instruction in the input device; transmitting data corresponding to the instruction from the input device to a remote server operatively connected to at least one remote display interface, and selectively transmitting the instruction from the remote server to the at least one interface wherein the at least one interface overlays the graphic onto video displayed on a display device.

### FIELD OF THE INVENTION

The present invention relates generally to a method and apparatus for providing computer-generated illustrations over a video image. More specifically, the invention relates to a method and apparatuses for generating graphic images on a remote display device utilizing a wireless communications device, a Point-Of-Presence (POP) server and a display device interface.

### BACKGROUND OF THE INVENTION

The value of a live television broadcast can often be increased by incorporating into it a live graphics illustration, usually with a digital painting application which allows the announcer to draw lines and symbols which appear over a live or videotaped image. Such a digital painting application is commonly known as a telestrator. This device allows, for example, an announcer to describe, on a displayed video image, a complex play in a sporting event, detail some weather phenomenon on a map or highlight some aspect of a news video. By augmenting what can be shown by the camera alone, these graphics greatly increase the viewer's understanding and enjoyment of a televised event.

Devices such as the telestrator discussed above have been the subject of various improvements. One such improvement is the capability of a broadcast announcer to generate graphics over a video image in real time wherein rough graphics generated by the user are converted into high quality graphics that are displayed on the transmitted video stream. Additional improvements have come in the form of the ability to animate displayed graphics over video playback and the capability to reorient the displayed graphics in three dimensions. The ability to incorporate sound effects and graphic enhancements to the video overlay has also advanced the state of the art. These advances however, have remained within the province of an announcer or other user that inputs the desired graphical overlay at the source of the video broadcast, i.e. the studio or station from which the video broadcast is being transmitted. As a result, all viewers of the same broadcast are subject to the graphical displays input at the broadcast source. Some of these features are shown, for example, in U.S. Pat. No. 6,057,833.

These improvements in currently available devices and methods have not, however, provided a capability for recipients of a broadcast video stream to independently illustrate broadcast video images with graphics of their own or overlay such illustrations onto the video display of selected remote display devices displaying the same video image.

### SUMMARY OF THE INVENTION

The invention solves these and other problems by providing a method and device that allows a viewer to generate and overlay graphical data on video images displayed on selected local and remote devices via a network.

According to an exemplary embodiment of the present invention, a method for displaying a graphic with video content displayed on a display device is provided. The method comprises: inputting at least one instruction, containing destination address information and a graphic, into an input device; storing the instruction in the input device; transmitting data corresponding to the instruction from the input device to a remote server, the server being operatively connected to at least one remote display interface identified by the destination address information, the display interface being connected to at least one display device and adapted to display the graphic on the display device; and selectively transmitting the instruction from the remote server to the interface wherein the interface overlays the graphic on video displayed on the display device.

According to another aspect of the present invention, a device for the transmission of graphical data to an addressable remote device is provided. The device comprises: an input module, adapted to receive and store graphical data input by a user; and a communication module adapted to transmit said graphical data received by the input module to a remote server, the remote server being operatively connected to an addressable display interface adapted to selectively display graphical data on at least one remote display device, wherein in response to at least one user instruction the graphical data is received by the input module, the communication module transmits the graphical data to the remote server, wherein the remote server transmits the graphical data to the display interface and wherein said display interface overlays the graphical data on video content displayed on the display device.

An advantage of the present invention is that it permits a subset of viewers of a broadcast video image to independently create and overlay graphics onto a broadcast video stream and communicate graphics between the subset of viewers.

The above embodiments and advantages of the present invention will become immediately apparent to those of ordinary skill in the art upon review of the Detailed Description and Claims to follow.

### BRIEF DESCRIPTION OF THE DRAWINGS

FIG. 1 depicts an arrangement in accordance with the present invention.

FIG. 2 depicts an input device in accordance with the present invention.

FIG. 3 depicts one embodiment of a display device interface in accordance with the present invention.

FIG. 4 depicts a method in accordance with the present invention.

### DETAILED DESCRIPTION

The present invention now will be described more fully hereinafter with reference to the accompanying drawings, in which exemplary embodiments of the present invention are shown. The various embodiments of the present invention include inter alia a device and method by which a graphic created by a viewer of a broadcast video stream can be overlaid onto the broadcast video stream and communicated to other selected viewers of the broadcast video stream via a network such as the Internet.

FIG. 1 depicts a schematic of an arrangement in accordance with a preferred embodiment of the present invention, all of which may be co-located at the subscriber's premises. The arrangement comprises an input device 101, a server 102, a display interface 103 and a display device 104. The input device 101 comprises a handheld wireless device adapted to communicate with the server 102, which may be, for example, an integrated set-top box or an internet server such as a POP server.

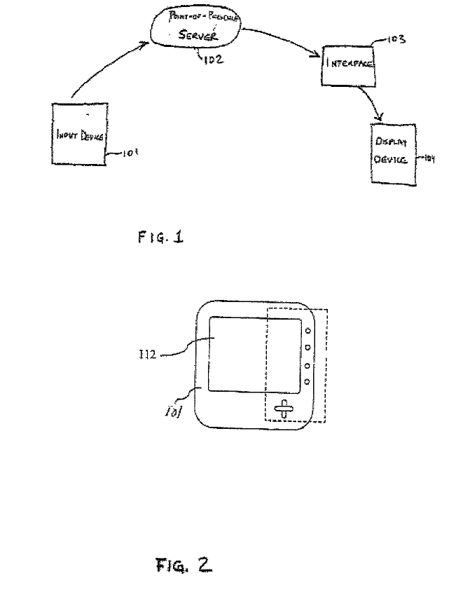

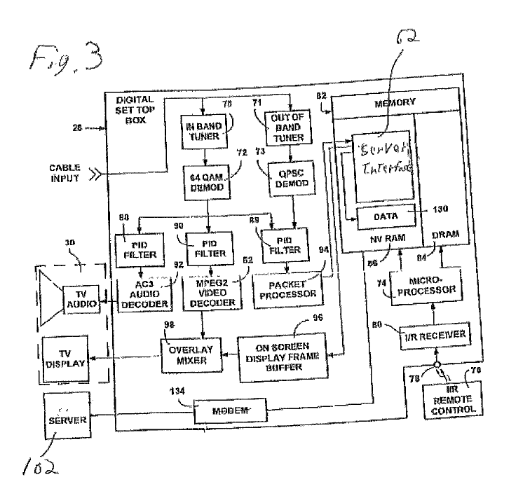

Preferably, as seen in FIG. 2, the input device 101 is equipped with a touch screen interface 112 that permits the input of data via a stylus. For example, input device 101 may be a wireless web appliance that is selected from the group of battery-powered, handheld devices that combine wireless transceiver, computer processor, memory, display and input devices with a web-browser type application that allows a combination of graphics and text (and in some cases, audio and motion video) to be displayed using data received over a wireless link. Wireless web appliances may include a touch screen (i.e., a transparent touch-sensitive panel) that provides for user input through touching or tapping appropriate icons and menu selections, typically using a stylus as a pointing device. In some applications of the invention, it may be desirable to capture data input through the recognition of handwritten symbols on the touch screen. In other applications, virtual keyboards and number pads may be displayed on the touch screen to provide for data entry by the user. Physical buttons may be used as alternative input devices or supplements to the touch screen. Moreover, external input devices (e.g., keyboard, mouse, bar-code scanner, etc.), external display devices (e.g., large format monitor), feature expansion and peripherals (e.g., memory card, printer) may be supported by input device 101 through the use of conventional I/O interfaces and expansion slots. Wireless web appliances are also referred to as “web pads” and may be used to provide World Wide Web access to users via an internet connection provided from the server 102. However, it is emphasized that World Wide Web access is not required to implement the principles of the invention.

The input device 101 may be realized in a special-purpose built device with the appropriate hardware and software to implement the features and functions described herein. In some applications of the invention, however, other devices such as personal digital assistants (“PDAs”), compact personal computers (often referred to as “Pocket PCs”), web tablet devices, and the like, may be modified or integrated with add-on modules to provide the appropriate feature set. For example, a PDA provides a user interface, display and hardware and operating system base that, when supplemented by wireless connectivity hardware and the appropriate software to implement the generation and insertion of graphical data, may be suitable for use in many applications of the invention.

The input device 101 includes a wireless transceiver to send and receive wireless signals to and from server 102 over a bi-directional wireless link. While infrared communications protocols may be used to implement the wireless communications, in most applications of the invention, a connection providing broader bandwidth is more preferable. For example, wireless radio frequency (“RF”) protocols, such as IEEE 802.11b, Bluetooth®, RangeLAN® or HomeRF®, provide higher data rates and are not limited to line-of-sight applications. In other embodiments of the invention, input device 101 may communicate with server 102 over a bi-directional wired link such as a coaxial cable.

In operation, a user desiring to overlay a graphic onto a video stream broadcast on a local or remote display device such as a television, for example, describes the graphic on the touch screen interface of the input device 101. Preferably, the graphic desired comprises a line, text, or a figure. In response to a user instruction, the graphic is then transmitted to the server 102. Preferably, the transmission of the graphical data input into the input device 101 is transmitted in real time or at the option of the user, in response to a “send” instruction. Once the transmitted graphical data is received and processed by server 102, the graphical data is transmitted by server 102 to the display device interface 103 over any of the aforementioned transmission means.

In addition, to facilitate the transmission of graphical data between input device 101 and display device interface 103, server 102 includes the application software and hardware necessary to process the graphic data received from input device 101 so that it may be properly overlaid onto the broadcasted video image received by the display device interface 103.

Display device interface 103 is adapted to display the received graphical data on the video stream displayed on an associated display device 104. Preferably, the server 102 and the device interface 103 are combined in an addressable set-top box adapted to display graphical data received on an associated display device 104 such as a television, for example. The video image displayed by display device 104 is then overlaid with the graphical data received by display interface 103. In this fashion, a viewer of a broadcast video stream can overlay graphical data onto the video stream and display the composite video image on the display device. Alternatively, the functionality of server 102 and the device interface can be incorporated into a Personal Video Recorder (PVR) device, thereby supplementing the traditional record and playback capabilities of a PVR by providing the capability to record the transmitted graphical data and overlain video image for playback at a later time.

One example of a digital set-top box that may be employed in the present invention is shown in FIG. 3. As shown in FIG. 3, a server interface 62 receives and processes the graphic data from server 102 via a communication module 134. The server interface 62 may be embodied in hardware, software, or a combination of the two. The configuration of communication module 134 will depend on the particular communications protocol that is employed between the server 102 and the set-top box 103. For example, communication module 134 may be a wired or wireless modem. The digital set-top box 28 also includes an in-band tuner 70 and an out-of-band tuner 71, along with appropriate demodulators 72 and 73, respectively. A microprocessor 74 controls the tuning operation of the tuners 70 and 71 based on commands received from a subscriber via an input device such as a keypad or an infrared remote control device 76.

In accordance with digital broadcasts wherein digitized channels are multiplexed as data packets onto an analog channel, the set-top box 28 also includes at least three packet identification (PID) filters 88-90 to extract the appropriate encoded data packets for a user-selected digital channel. Based on the user-selected display, audio and other requirements, the microprocessor 74 writes an identification value to each of the PID filters 88-90, whereby the filters 88-90 pass only those packets corresponding to that value. As shown in FIG. 3, one of the PID filters, filter 88, provides the filtered packets to an audio decoder 92 which decodes the digital audio data (encoded according to the AC3 format), while another PID filter 90 provides filtered packets (MPEG2 encoded) to the video decoder 52.

As can be readily appreciated, in addition to line-level audio and video outputs, the resulting video signal may be output from the set-top box 28 with separate luminance and chrominance signals (SVHS format). As is typical, the set-top box 28 may also contain a modulator (not shown) for combining the audio and video signals onto a modulated carrier channel such as channel 3 or 4, for compatibility with television sets not having separate audio and video inputs.

A third PID filter 89 is provided to extract in-band and out-of-band data directed to the operation of the set-top box 28. A packet processor 94 handles those packets. The set-top box is also equipped with an on-screen display frame buffer (OSD) 96 capable of superimposing alphanumeric characters, other symbols and bitmap graphics over a displayed image. To accomplish this superimposition, an overlay mixer 98 is provided to appropriately combine the video outputs of the video decoder 52 and the OSD 96.

In some embodiments of the invention, various servers 102 located on various subscriber premises can be connected in a Peer-To-Peer network so that a given subscriber can selectively overlay graphical data onto a broadcast video stream being watched by other subscribers. The present invention allows the graphical data to be transmitted to as few as one subscriber or to the entire network of subscribers as desired. To this end the user instruction sent from the input device 101 to server 102 includes, in addition to the graphical data, a destination address of the selected subscribers who are to receive and display the graphical data. If server 102 is an Internet server, it may directly transmit the user instruction over the Internet to the selected subscriber or subscribers corresponding to the destination address or addresses included in the user instruction. Alternatively, if server 102 is an addressable set-top box, it may directly transmit the user instruction to selected subscribers via the cable network to which it is operatively connected. In this way a subset of viewers of a television broadcast, for example, can independently communicate graphical information with each other simply by describing a desired graphic on the input device 101, and transmitting it to a desired address for viewing in conjunction with the television broadcast.

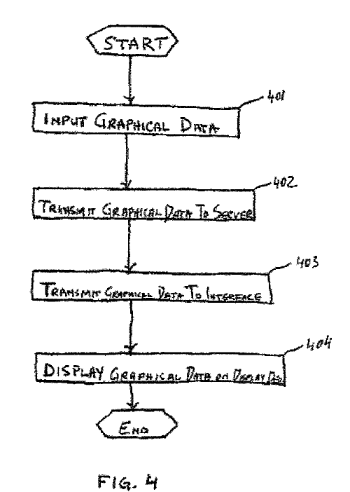

The method of the present invention, in accordance with the arrangement depicted in FIG. 1 and incorporating display interfaces 103 that are arranged in a peer-to-peer network, is depicted in FIG. 4. As shown therein, the method of a preferred embodiment of the present invention comprises the input of graphical data in an input device as depicted by input device 101 of FIG. 1. This step is depicted as step 401 of FIG. 4. Once the graphical data is input into device 101 of FIG. 1, the graphical data is transmitted to server 102 of FIG. 1. This step is depicted as step 402 of FIG. 4. Based on addressing information incorporated as part of the transmission of the graphical data from input device 101 to server 102, the graphical data is selectively transmitted to at least one selected display device interface 103.

Preferably, the selected display interface is at a location remote from input device 101 of FIG. 1 and corresponds to a device owned or operated by a subscriber to a Peer-to Peer network. This step is depicted as step 403 of FIG. 4. The display device interface is preferably connected to a display device 104 wherein graphical data received by interface 103 is displayed and incorporated into a video stream displayed on the associated display device 104. Preferably, graphical data transmitted by a user or participant of a Peer-To-Peer network incorporating the present invention will be able to erase the graphical data transmitted from the destination display device a desired. Optionally, the graphical display would be erased automatically after a predetermined time. It will be appreciated by one skilled in the art that display device interface 103, and display device 104 could be combined as a single unit while continuing to accomplish the objectives of the present invention.

All the features disclosed in this specification (including any accompanying claims, abstract and drawings), and/or all of the steps or any method or process so disclosed, may be combined in any combination, except combinations where at least some of the features and or steps are mutually exclusive. Each feature disclosed in this specification (including any accompanying claims, abstract and drawings) may be replaced by alternative features serving the same equivalent or similar purpose, unless expressly stated otherwise. Thus unless expressly stated otherwise, each feature disclosed is one example only of a generic series of equivalent or similar features. Moreover, although a specific embodiment is specifically illustrated and described herein, it will be appreciated that modifications and variations of the invention are covered by the above teachings and within the purview of the appended claims without departing from the spirit and intended scope of the invention.

What is claimed is:

1. A method for incorporating a graphic with a received video broadcast displayed on a display device comprising:
inputting at least one instruction corresponding to a graphic into an input device;
storing said at least one instruction in said input device;
transmitting data corresponding to said instruction from said input device to a remote server, said server being operatively connected to at least one remote display interface of the display device and being further connected to at least one display adapted to display said graphic on said display device; and
selectively transmitting said instruction from said remote server to said at least one display interface wherein said at least one display interface overlays said graphic on the received video broadcast displayed on said display device.

2. The method of claim 1 wherein said at least one instruction includes destination address information and the step of transmitting data includes the step of transmitting the data to a remote server operatively connected to at least one remote display interface corresponding to said destination address.

3. The method of claim 2 further comprising a plurality of remote display interfaces arranged in a peer-to-peer network.

4. The method according to claim 1 wherein said at least one instruction comprises a stylus input on a touch screen device.

5. The method according to claim 1 wherein said input device comprises a wireless handheld communication device.

6. The method according to claim 1 wherein said remote server comprises an Internet server.

7. The method according to claim 1 wherein said remote server comprises an addressable set-top box.

8. The method according to claim 1 wherein said display interface comprises a set-top box adapted to overlay graphic images on a received video broadcast displayed on a display device.

9. The method according to claim 1 wherein said remote server and said display interface comprise a Personal Video Recorder adapted to at least one of receive, overlay, record and selectively playback said graphical data on a received video broadcast for display on said display device.

10. The method according to claim 1 wherein said at least one display device comprises one of a television and a monitor.

11. A device for the transmission of graphical data to a remote device comprising:
an input module, said input module adapted to receive and store graphical data input by a user; and
a communication module, said communication module adapted to transmit said graphical data received by said input module;
a remote server operatively connected to the communication module for receiving the graphical data; and
at least one display device having a display interface operatively connected to the remote server, said display device being adapted to display a received video broadcast and said graphical data, wherein in response to at least one user instruction said graphical data is received by said input module, said communication module transmits said graphical data to said remote server, said remote server transmits said graphical data to said display device interface, wherein said display interface overlays said graphical data on the received video broadcast displayed on said display device.

12. The device of claim 9 wherein said graphical data includes destination address information of the display device and said remote server transmits said graphical data to the display device corresponding to the destination address.

13. The device according to claim 9 wherein said input module comprises a touchscreen user interface adapted to receive a stylus input.

14. The device according to claim 9 wherein said remote server comprises an addressable set-top box.

15. The device according to claim 9 wherein said input and communication modules comprise a wireless handheld device.

16. The device according to claim 9 wherein said remote server comprises an Internet server.

17. The device according to claim 9 wherein said communication module comprises a cable modem.

18. The device according to claim 9 wherein said remote server comprises a computer.

19. The device according to claim 9 wherein said communication module comprises a wireless modem.

20. The device according to claim 9 wherein said display interface is an addressable set-top box.

21. The device according to claim 9 wherein said graphical data comprises at least one of a manually described line, text, and symbol.

22. The method according to claim 9 wherein said remote server and said display interface comprise a Personal Video Recorder adapted to at least one of receive, overlay, record and selectively playback said graphical data on a received video broadcast for display on said display device.

23. A method for incorporating a graphic with a received video broadcast displayed on a display device comprising:
receiving at a remote server at least one instruction corresponding to a graphic from an input device, said server being operatively connected to at least one display device adapted to display said graphic thereon; and
selectively transmitting said instruction from said remote server to said at least one display device wherein said at least one display device overlays said graphic on the received video broadcast displayed on said display device.
